(19) United States
(12) Patent Application Publication
(10) Pub. No.: US 2008/0246611 A1
(43) Pub. Date: Oct. 9, 2008

(54) METHOD AND APPARATUS FOR DETECTING THE PRESENCE OF RFID DEVICES AND MODIFYING THE SAME

(76) Inventors: John King, Westmont, IL (US); Jill Zako, Westmont, IL (US)

Correspondence Address: Brannon & Associates PC, 1 North Pennsylvania Street, Suite 520, Indianapolis, IN, 46204, US

(21) Appl. No.: 12/062,955

(22) Filed: Apr. 4, 2008

Related U.S. Application Data
(60) Provisional application No. 60/910,029, filed on Apr. 4, 2007.

(51) Int. Cl. G08B 13/22

(52) U.S. Cl. 340/572.3; 340/572.1

(57) ABSTRACT

An apparatus for detecting and interacting with radio frequency identification devices, including a transceiver, a scanner operationally connected to the transceiver and tuned to scan a pre-selected set of frequencies typically associated with RFID tags, a microprocessor operationally connected to the transceiver, a user interface operationally connected to the microprocessor, and a power supply operationally connected to the microprocessor and to the transceiver. The apparatus may be selectively actuated to detect and interrogate RFID tags, to reprogram RFID tags, and/or to destroy RFID tags.

### CROSS-REFERENCE TO RELATED APPLICATIONS

This application claims priority to co-pending U.S. Provisional Patent Application Ser. No. 60/910029, filed on Apr. 4, 2007.

### BACKGROUND

Radio frequency identification (RFID) devices have become ubiquitous in our lives. As nondescript one- or two-way communications devices that can be unobtrusively attached to or within products, such devices inherently carry a risk for the violation of personal privacy. For example, even though many product tags include RFID devices installed for the purpose of tracking inventory or deterring shoplifting, those tags often remain activated after the product has left the store and may be queried by anyone with the right know-how and equipment. Thus, there is a need for a means for detecting and nullifying RFID devices that have outlived their usefulness as tracking devices and/or theft deterrents. The present novel technology addresses this need.

### SUMMARY

The present novel technology relates generally to the field of electronics and, more particularly, to a method and apparatus for detecting active and/or passive RFID tags and recording the presence of, deactivating, and/or reprogramming the same. One object of the present novel technology is to provide an improved system of detecting RFID devices. Related objects and advantages of the present novel technology will be apparent from the following description.

### BRIEF DESCRIPTION OF THE DRAWINGS

FIG. 1 is a schematic view of a device for detecting and interacting with RFID tags according to a first embodiment of the present novel technology.

FIG. 2 is a diagrammatic view of a method for detecting and interacting with RFID tags using the embodiment of FIG. 1.

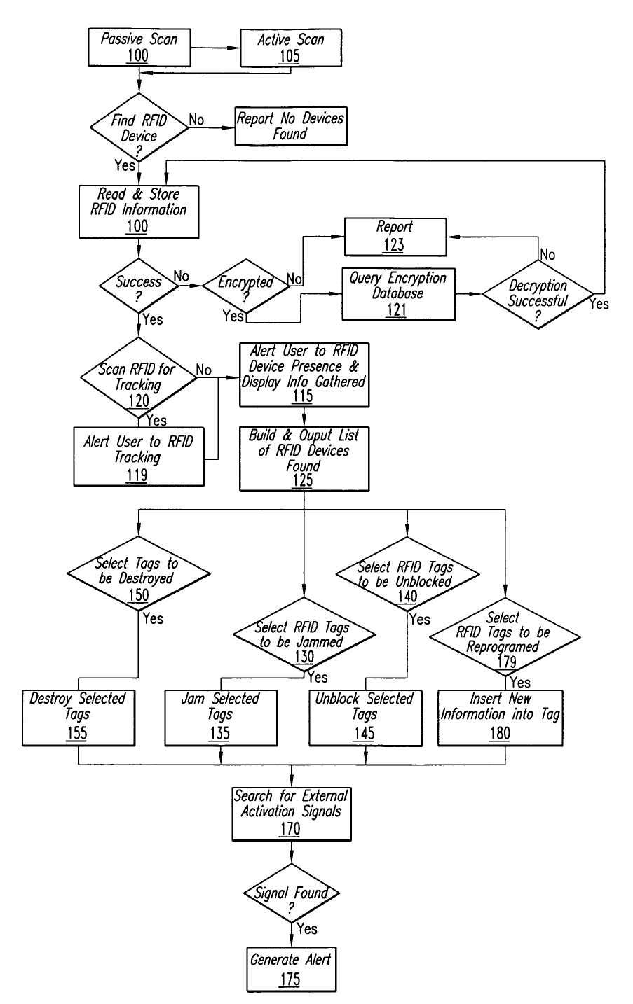

### DETAILED DESCRIPTION OF THE PREFERRED EMBODIMENT

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

Since RFID devices by design transmit information when queued, RFID devices inherently have potential for privacy abuse. The novel technology discussed hereinbelow device addresses privacy concerns without obviating the intended purpose and justification for the use of RF ID's. RFID's were initially developed for tracking items from manufacturing through shipping and retail presentation. They allow for inventory management and are used for actual product identification and for pricing at a point of sale. However, once the sale is completed and the customer departs, the RFID device may continue to transmit information if not properly deactivated. In other words, if an RFID device is not deactivated at the point of sale, it remains detectable for subsequent monitoring. It is conceivable that a third party who simply wanted to know about one's purchasing patterns could independently and externally monitor active RFID tags.

The problem gets exacerbated when RFID tags are placed in such non-retail items as personal identification or charge cards. Without serious encryption, these tags could be ‘snooped’ upon externally by those wishing to collect information. There have been significant concerns expressed that such ubiquitous RFID tagging could create a large potential for the ‘theft’ of personal information and subsequent identity theft. Furthermore, the presence of such RFID tagged information could generate a vehicle whereby the tracking of an individual's movements could be monitored. By way of example, the fob issued by Mobile Oil for ‘pay at the pump’ purchases of gasoline has reportedly been independently read by technicians as a test of its security (it failed).

While there is a plethora of equipment available for detecting and scanning RFID devices, such equipment is mostly constrained to commercial devices designed and marketed for reading the RFID for its actual intended purpose. Those few detectors/readers available to the general public are very limited in functionality. The novel device described hereinbelow both extends and improves upon the functionality available, providing for the individual to manage RFID use as it pertains to his or her personal choices.

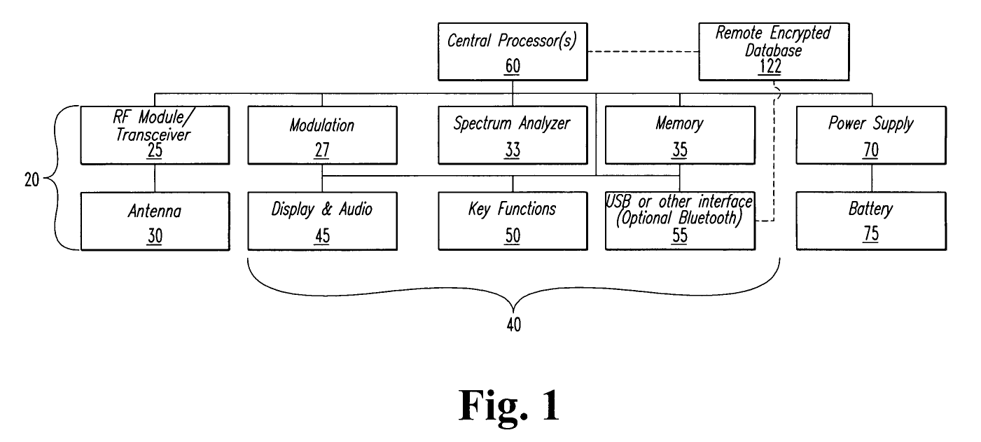

According to one embodiment and as illustrated in FIG. 1, the present novel technology relates to a device 10 for detecting and nullifying RFID tags or transmitters 15. The device 10 includes a broad spectrum scanner 20 configured to detect and read active RFID devices 15. The scanner 20 is typically configured to monitor those frequencies commonly used by RFID tags 15. More typically, the scanner 20 is further configured to generate a RF pulse for querying passive RFID devices 15. The scanner 20 typically includes a transceiver 25, a modulation circuit 27 and antenna 30 and is more typically operationally connected to (or includes incorporated therein) a spectrum analyzer 33 and/or a memory device 35 for recording the identification of RFID devices 15 and, more typically, for recording the information stored on RFID devices 15 that are read by the scanner 20. A user interface 40 is also typically connected to the scanner 20 displaying information regarding detected RFID tags 15 and their stored information and for allowing the user to select response options. These response options typically include one or more of the following: destroying of the RFID device 15 by generating a pulse at the RFID's receiving frequency of sufficient strength to overload and damage the RFID tag 15; reprogramming the RFID tag 15 with disinformation; blocking or jamming the RFID tag's 15 frequency to prevent communications therewith; logging the RFID tag 15 and/or its information for later reference; or the like. Some RFID tags 15, such as those in identification badges or identification cards, could be selectively noted such that they ignored by the device 10.

The user interface 40 typically includes an operationally connected display device 45, a data entry interface 50 (such as a keypad), and an electronic interface 55 (such as a USB port). Further, the scanner portion 20 and memory portion 35 are typically connected in electric communication with a microprocessor 60. The device 10 also typically includes a power supply 70 operationally connected to the scanner 20, memory 35, and/or microprocessor 60.

In operation, the device 10 passively scans 100 typical frequencies used in active RFID tags and detects their presence. The device 10 next actively scans 105 with RF output to activate and detect passive RFID devices 10. If either type tag 15 is found, an attempt is typically made to read and store 110 the information contained on the RFID and then notify 115 the user, such as via an audible or vibratory alarm. Optionally, the device 10 may then scan for external tracking stations 120 to warn a user 119 that at least one RFID tag 15 within range is being scanned. If the scanner 20 reads an RFID device with an encryption, the device 10 may then query 121 its memory 35 and/or a remote encryption database 122 to procure a valid decryption code. The device may then attempt to decrypt and read the information on the encrypted RFID tag 15. If no tags are found or if the tags found are encrypted and no decryption is available, the device 10 may then display a message 123 regarding the same.

The device 10 then typically builds and displays a table of units found 125. The device 10 then typically gives the user the option to highlight on screen or otherwise identify which, if any, RFID tags 15 they wish to block or jam 130. The device 10 is then activated to block or scramble 135 those selected RFID tags 10. If it is desired that one or more RFID tag be activated, the user may again highlight or identify the selected RFID tag(s) on the list to be unblocked 140 and the device 10 then suppresses the blocking 145 of the selected tags 10 (or unblocks 145 blocked tags 10).

Typically, the device 10 will give the user the option of selecting for destruction 150 and then permanently deactivating or destroying 155 an RFID tag 15, such as by generating an overload pulse on the tag's 15 receiving frequency.

The device 10 is typically configured to include a receiver 25 and spectrum analyzer 33 tuned to scan typical frequencies employed, a (typically) very small microprocessor 60 with memory 35 and a control unit 40 operationally connected to the receiver/spectrum analyzer 25, 33, an LCD or like type display 45 operationally connected to the microprocessor 60 for reporting detected RFID tags 15, an alarm function 45 operationally connected to the microprocessor 60, a (typically low level) RF source 25 tunable to the detected frequency(s) (and probably limited to 100 milliwatts to comply with FCC regulations) to be employed as a signal blocking device and/or deactivation device, a USB interface 55 for both loading firmware and for interrogating obtained data from RFID tags 15, a power supply 70, such as a battery 75, wall current, a charging circuit, or the like, and a user interface 40 (such as key functions) operationally connected to command the device 10.

In another embodiment, the device 10 will further include the functionality of searching for externally generated RFID tag activation signals 170 and will generate an alert signal 175 upon receipt of such an activation signal, such that the user will know when an RFID tag in his possession or vicinity is being externally queried. In still another embodiment, the device 10 may be selectively actuated 179 to reprogram an RFID tag with new information 180. In yet another embodiment, the device 10 will include encryption or like safeguards to prevent it from becoming an identifier in its own right, capable of being queried and/or otherwise identified.

The device 10 may optionally be connected through its electronic interface 55, either directly or via computer, to an Internet web site to facilitate software updates and data base revisions of known codes on a subscription basis. The device 10 may also be used to submit (such as on a fee for service basis) obtained RFID data for subsequent analysis via the web site.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

We claim:

1. An apparatus for detecting and interacting with radio frequency identification devices, comprising:
a transceiver;
a scanner operationally connected to the transceiver and tuned to scan a pre-selected set of frequencies typically associated with RFID tags;
a microprocessor operationally connected to the transceiver;
a user interface operationally connected to the microprocessor;
a power supply operationally connected to the microprocessor and to the transceiver;
wherein the apparatus may be selectively actuated to detect and interrogate RFID tags;
wherein the apparatus may be selectively actuated to reprogram RFID tags; and
wherein the apparatus may be selectively actuated to destroy RFID tags.

2. The apparatus of claim 1 and further comprising:
an signal generator operationally connected to the microprocessor;
wherein the apparatus generates a signal in response to the detection of an RFID device.

3. The apparatus of claim 1 wherein the user interface further includes a visual display portion operationally connected to the microprocessor, a keypad portion operationally connected to the microprocessor, and an electronic interface portion operationally connected to the microprocessor.

4. The apparatus of claim 1 wherein the scanner further includes a spectrum analyzer operationally connected to the transceiver, a modulation circuit operationally connected to the transceiver, and an antenna operationally connected to the transceiver.

5. A system for detecting and modifying radio frequency tags, comprising:
a transceiver portion;
a scanner portion operationally connected to the transceiver portion;
a microprocessor portion operationally connected to the transceiver portion;
a user interface portion operationally connected to the microprocessor portion;
a power supply portion operationally connected to the microprocessor portion and to the transceiver portion; and
a database portion for storing known encryptions;
wherein the database portion my be queried by the microprocessor;
wherein the scanner portion is tuned to scan a pre-selected set of frequencies typically associated with RFID tags;
wherein the system may be actuated to detect and interrogate RFID tags;
wherein the system may be selectively actuated to reprogram RFID tags; and
wherein the system may be selectively actuated to destroy RFID tags.

6. The system of claim 5 wherein the database portion is remotely maintained and wherein the database portion is connected in electric communication to the microprocessor via the Internet.

7. The system of claim 5 and further comprising:
an signal generator portion operationally connected to the microprocessor portion;
wherein the system generates a signal in response to the detection of an RFID device.

8. The system of claim 1 wherein the user interface portion further includes a visual display portion operationally connected to the microprocessor portion, a keypad portion operationally connected to the microprocessor portion, and an electronic interface portion operationally connected to the microprocessor portion.

9. The system of claim 1 wherein the scanner portion further includes a spectrum analyzer portion operationally connected to the transceiver portion, a modulation portion operationally connected to the transceiver portion, and an antenna portion operationally connected to the transceiver portion.

10. A method of detecting and modifying radio frequency identification devices (RFIDs), comprising:
a) scanning for the presence of RFIDs;
b) reporting the presence of discovered RFIDs;
c) querying discovered RFIDs; and
d) displaying information recovered from queried RFIDs;

11. The method of claim 10 and further comprising:
e) displaying a list of all RFIDs discovered;
f) selecting RFIDs from the list to be blocked; and
g) blocking selected RFIDs.

12. The method of claim 10 and further comprising:
h) displaying a list of all RFIDs discovered;
i) selecting RFIDs from the list to be destroyed; and
j) destroying selected RFIDs.

13. The method of claim 10 and further comprising:
k) displaying a list of all RFIDs discovered;
l) selecting RFIDs from the list to be reprogrammed; and
m) reprogramming selected RFIDs.

14. The method of claim 11 and further comprising:
n) displaying a list of all RFIDs discovered;
o) selecting RFIDs from the list to be unblocked; and
p) unblocking selected RFIDs.

15. The method of claim 10 and further comprising:
q) displaying a list of all RFIDs discovered;
r) selecting RFIDs from the list to be blocked;
s) blocking selected RFIDs;
t) selecting RFIDs from the list to be destroyed;
u) destroying selected RFIDs;
v) selecting RFIDs from the list to be reprogrammed; and
w) reprogramming selected RFIDs.

16. The method of claim 11 and further comprising:
x) searching for external RFID activation signals; and
y) generating an alarm signal in response to a detected RFID activation signal.

17. The method of claim 10 wherein steps a through d are carried out on a platform comprising:
a transceiver portion;
a scanner portion operationally connected to the transceiver portion;
a microprocessor portion operationally connected to the transceiver portion;
a user interface portion operationally connected to the microprocessor portion;
a power supply portion operationally connected to the microprocessor portion and to the transceiver portion; and
a database portion for storing known encryptions.

18. The method of claim 15 where steps a through d and q through w are carried out on a platform comprising:
a transceiver portion;
a scanner portion operationally connected to the transceiver portion;
a microprocessor portion operationally connected to the transceiver portion;
a user interface portion operationally connected to the microprocessor portion;
a power supply portion operationally connected to the microprocessor portion and to the transceiver portion; and
a database portion for storing known encryptions.

19. The method of claim 10 and further comprising:
z) communicating information recovered from queried RFIDs for identification.

20. The method of claim 19 wherein the communicated information recovered from queried RFIDs is also decoded.
